(19) United States
(12) Patent Application Publication
(10) Pub. No.: US 2015/0236752 A1
(43) Pub. Date: Aug. 20, 2015

(54) METHOD FOR SELECTION OF UNIQUE NEXT-TIME-INTERVAL INTERNET PROTOCOL ADDRESS AND PORT

(71) Applicant: Raytheon BBN Technologies Corp., Cambridge, MA (US)

(72) Inventors: Alen Cruz, Tampa, FL (US); Gangadhar Ganga, Clearwater, FL (US); Paul F. Beraud, III, Parrish, FL (US); Suzanne P. Hassell, Clearwater, FL (US); Ledford J. Meadows, III, Wesley Chapel, FL (US)

(73) Assignee: Raytheon BBN Technologies Corp., Cambridge, MA (US)

(21) Appl. No.: 14/185,020

(22) Filed: Feb. 20, 2014

(51) Int. Cl. H04B 1/7156; H04L 29/06; H04B 1/713

(52) U.S. Cl. CPC H04B 1/7156; H04B 1/713; H04L 63/1408

(57) ABSTRACT

Embodiments for providing a next-time-interval routing parameter to a destination node are generally described herein. In some embodiments, a hopped routing parameter is calculated at a sending node using a static routing parameter of a destination node. The hopped routing parameter and source timing are encoded. The encoded hopped routing parameter and source timing are provided in the address fields of packets.

### GOVERNMENT RIGHTS

This invention was made with Government support under Contract Number W15P7T-12-C-A111. The Government has certain rights in this invention.

### BACKGROUND

Intrusion detection systems attempt to catch the adversary, provide visualization tools that allow visualization of the network in real time, and provide instantaneous alerting systems. Like network defenders, an adversary also attempts to visualize the network. Current network attacks assume static locations of servers and services. Thus, one way to degrade the adversary's network view is to introduce dynamic network modifications that make it harder for adversaries to map the network.

Intrusion detection systems monitor the operations of a system and looks for deviations in usage. The intrusion detection system gathers and analyzes information from various areas within a computer or a network to identify possible security breaches, which include intrusions from outside the system and misuse from within the organization. While a firewall prevents systems from outer intrusion, an intrusion detection system evaluates a suspected intrusion once it has taken place and signals an alarm within a system. Nevertheless, attackers may attack servers at any time by flooding serves with malicious packets. Passive defenses such as firewalls and intrusion detection systems thus do not provide effective countermeasures.

In the modern military communications, frequency interference is widely used as a deception countermeasure. Besides deception means, an offensive evasive tactic of frequency hopping is also widely utilized to keep the enemies in the dark by changing the radio frequency pseudo-randomly. Similarly, a proactive tactic of full service hopping, which changes the service information pseudo-randomly, including service port, network address, service slot, cryptographic algorithm, and even the service protocol, may be used to provide proactive countermeasures.

Such cyber maneuvering techniques may be used to thwart potential attackers in high-threat environments by providing static address and/or port to hopped address and/or port. The intent of cyber maneuvering is to place computer network defense technology into a proactive state, thereby shifting the advantage away from the attacker. By constantly changing the characteristics of the networks, cyber maneuvering provides a more robust and trusted networking solution that would thwart an intrusion attempt by randomly changing network settings while simultaneously allowing the network to operate normally for an authenticated node. Thus, cyber maneuvering is a technique of dynamically modifying aspects and configurations of networks, hosts and applications in a manner that is undetectable and unpredictable by an adversary but still manageable for network administrators. By using cyber maneuvering techniques, observers may be prevented from discerning future hopped addresses from current hopped addresses. However, prior cyber maneuvering techniques were dependent upon accurate time synchronization across nodes participating in a hopping network. Other techniques used additional data in the payload which reduced throughput to address susceptibility to time variations due to network latency.

### BRIEF DESCRIPTION OF THE DRAWINGS

FIG. 1 illustrates port hopping according to an embodiment;

FIG. 2 illustrates Internet Protocol (IP) Hopping according to an embodiment;

FIG. 3 illustrates end hopping according to an embodiment;

FIG. 4 illustrates scan/attack on a hopping application according to an embodiment;

FIG. 5 illustrates an IPv4 header format according to an embodiment;

FIG. 6 illustrates hopping on a class C address according to an embodiment;

FIG. 7 shows hopping on class B/D/E according to an embodiment;

FIG. 8 illustrates an open shortest path first (OSPF) packet according to an embodiment;

FIG. 9 illustrates a network of routers using OSPF according to an embodiment;

FIG. 10 illustrates packet flow through OSPF network hopping data according to an embodiment;

FIG. 11 illustrates a routing information protocol (RIP) version two (v2) packet according to an embodiment;

FIG. 12 illustrates multicast flow according to an embodiment;

FIG. 13 illustrates hopped and un-hopped data flow according to an embodiment; and

FIG. 14 illustrates a block diagram of an example machine for selecting unique next-time-interval internet protocol address and port according to an embodiment

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass available equivalents of those claims.

Embodiments described herein provide mapping for Internet Protocol (IP) addresses and ports for given time interval hops without synchronized time information being shared among nodes. Embodiments of the method provide cyber maneuvering as well as additional advantages. For example, source timing makes calculations independent from time variations. A static address and/or port number is provided and a hopped address and/or port number is calculated guaranteeing that there are no collisions for the same time interval. In addition, a mapping from time interval to time interval is made in a pseudo-random fashion to prevent prediction of next time interval values. Calculations may be performed in an efficient manner to reduce resource utilization.

An embodiment transmits 16 bits of encoded data in the IPv4 address field to facilitate IP address and port hopping by replacing the address of source and destination in IP and Address Resolution Protocol (ARP) packets. ARP is a protocol that is used for resolution of network layer addresses into link layer addresses. This does not modify any other IP/ARP fields such as the payload (checksums are updated).

The number of bits can vary based on the subnet mask of the network. For example, the number of bits may be between 1 and 32 bits for IP version 4 (IPv4). Source timing information and/or Hopping local area network (LAN) Identifier (ID) information may also be transmitted. For IP version 6 (IPv6), this approach is also utilized, including neighbor discovery. The number of encoded data bits may be increased up to 128.

A HAIPE (High Assurance Internet Protocol Encryptor) is a Type 1 encryption device, which is certified by the National Security Agency (NSA) for use in cryptographically securing classified U.S. Government information. Embodiments may also use in HAIPE (transmit mode or tunnel mode). The source field information may be encoded when hopping. This approach does not hop the destination address when sending packets off the hopping network. The same static destination has a different hopped address as it traverses different networks.

Embodiments described herein use the time from the source node to perform the decode calculations which allows for the times used for the decode calculations to be independent from source to destination. Differences may be distinguished according to source timing and the use of time, timing intervals, and hopping LAN ID. The use of the timing intervals make the amount of data used smaller compared to sending entire time information with each packet. The use of Hopping LAN IDs allows for the coexistence of multiple method instances in the same physical LAN.

To support cyber maneuvering, time is included in a packet by a source node prior to transmission and used by a receiving node to unhop the packet. This makes time synchronization unnecessary. IP source and destination addresses and TCP/UDP ports are replaced just prior to transmission. This is more efficient than encapsulation because no additional bytes are used. It is also transparent to layers above the link layer, which still see the static (unhopped) IP addresses and ports.

In addition, embodiments of the methods described herein are not limited to point-to-point. An embodiment is also capable of operating across entire area networks (e.g., LAN, wide area networks (WAN), etc.). For the transmission of the data, such as the source time, the address fields in IP and APR packets are used, whereas previous techniques to transmit data using IP/ARP packet involve additional data in the payload which reduces throughput.

There are various methods of implementing a hopping scheme. With Time based hopping, each host either moves at a designated time or moves at its own time slot. For example, if the time interval is 24 hours, the network may be changed once a day by implementing such changes at midnight or one an hour. A control channel could be used to hop, wherein each host registers changes and other hosts pick up changes. This is subject to control channel attacks as each node must register and query for other hosts. Method/key-based hopping is based on the use of a method and a cryptographic key, which may be public or shared. To avoid control channel problems each host, at a certain time switches to a new hop based on the key and the method. Packet-based hopping occurs when a certain number of packets have been received. Hopping over multiple communication channels may be used by spreading data over multiple ports and interleaved with fake data. Hybrid hopping uses a control channel to establish new hosts to the scheme. However, once a host is in, moves are based on time and method/key. New hosts may be subject to problems if the control channel is attacked, and could be synced manually, but the server in the scheme may continue to operate without the control channel.

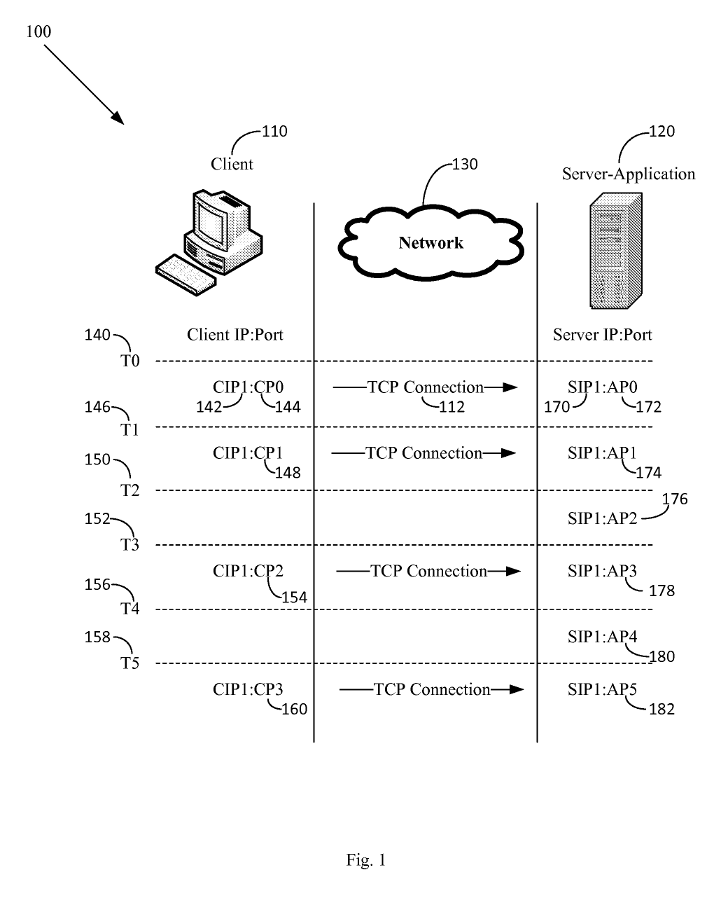

FIG. 1 illustrates port hopping 100 according to an embodiment. Port Hopping is when the application or service on the server (destinations port) changes to a new port in a way that is predictable to a client but not predictable by an adversary. In FIG. 1, a client 110 is coupled to a server application at a server 120 through a network 130. At time t₀ 140, the client IP (CIP) is CIP1 142 and the client port (CP) is zero, CP0 144. Client 110 is using a TCP connection 112 to connect to the server 120. The client 110 accesses the server 120 using server IP 1 (SIP1) 170 and application port 0 (AP0) 172. At time t₁ 146, the client 110 switches to client port 1 148 and the server 120 switches to application port 1 174. At time t₂ 150, the server 120 switches to application port 2 176. At time t₃ 152, the client 110 switches to client port 2 154 and the server 120 switches to application port 3 178. At time t₄ 156, the server 120 switches to application port 4 180. At time t₅ 158, the client 110 switches to client port 3 160 and the server 120 switches to application port 5 182. Accordingly, a service on a server 120 changes port numbers in such a manner as to not be predicted by an adversary but able to be determined by a friendly node.

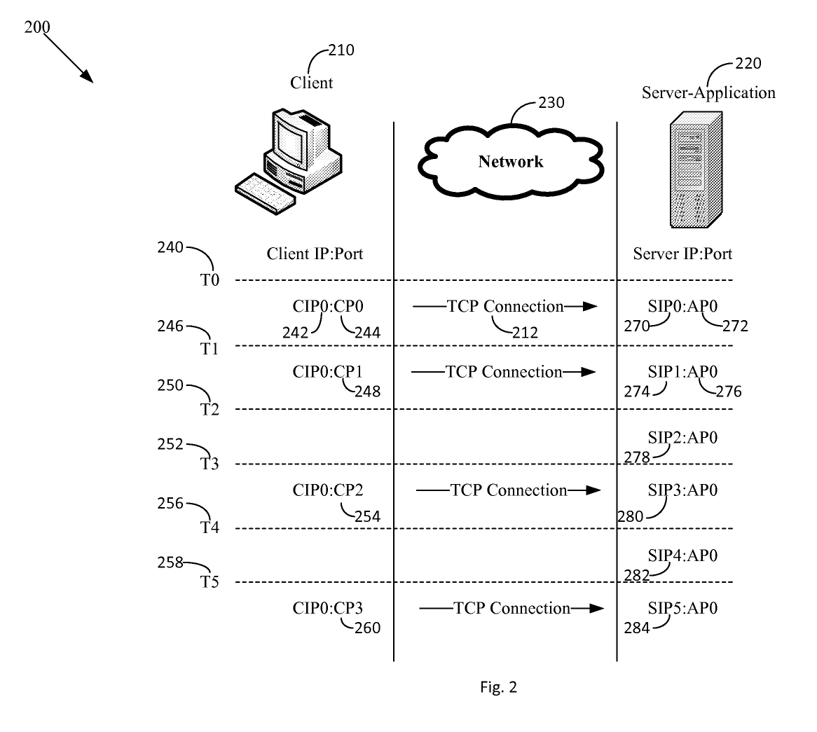

FIG. 2 illustrates IP Hopping 200 according to an embodiment. A client 210 or a server 220 changes IP addresses in such a manner as to not be predicted by an adversary but able to be determined by a friendly node. In FIG. 2, a client 210 is coupled to a server application at a server 220 through a network 230 using a TCP connection 212. At time t₀ 240, the client IP (CIP) is CIP0 242 and the client port (CP) is zero, CP0 244. The client 210 accesses the server 220 via the network 230 using server IP 0 (SIP0) 270 and application port 0 (AP0) 272. At time t₁ 246, the client 210 switches to client port 1 248 and the server 220 switches to server IP 1 274 while application port remains AP0 276. At time t₂ 250, the server 220 switches to server IP 2 278. At time t₃ 252, the client switches to client port 2 254 and the server 220 switches to server IP 3 280. At time t₄ 256, the server switches to server IP 4 282. At time t₅ 258, the client 210 switches to client port 3 260 and the server 220 switches to server IP 5 284. Just as with port hopping, the server has a pool of IP addresses to move between again in a manner that is predictable by a client but not by an adversary.

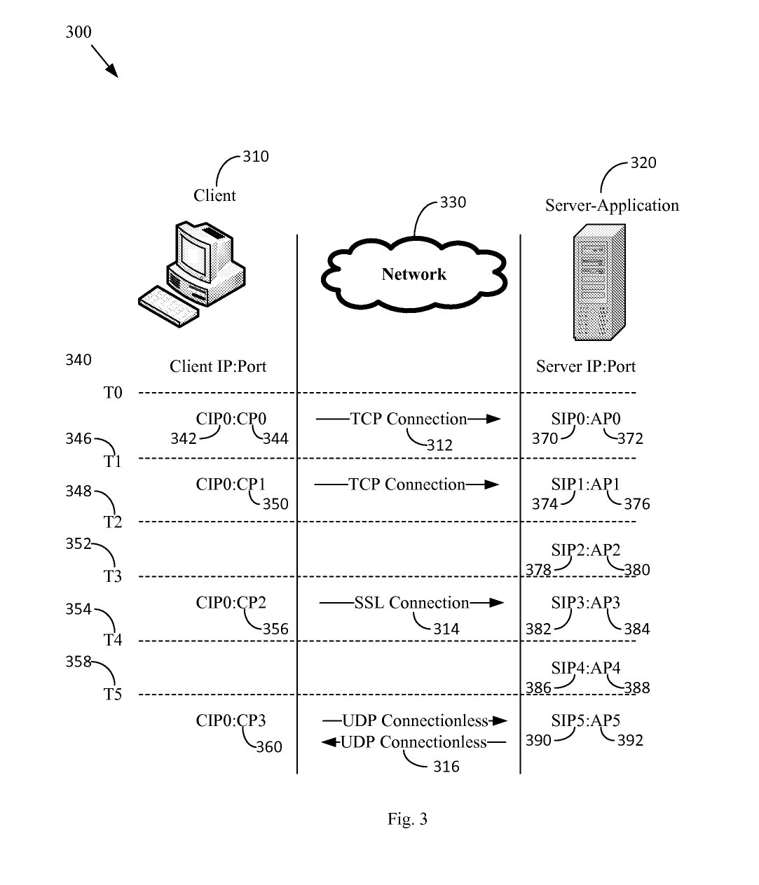

FIG. 3 illustrates end hopping 300 according to an embodiment. In FIG. 3, a client 310 is again coupled to a server application at a server 320 through a network 330. At time t₀ 340, the client IP (CIP) is CIP0 342 and the client port (CP) is zero 344. The client 310 accesses the server 320 via the network 330 using a TCP connection 312, and server IP 0 (SIP0) 370 and application port 0 (AP0) 372. At time t₁ 346, the client 310 switches to client port 1 350 and the server 320 switches to server IP 1 374 and application port 1 376. At time t₂ 348, the server 320 switches to server IP 2 378 and application port 2 380. At time t₃ 352, the client 310 switches to client port 2 356 and the server 320 switches to server IP 3 382 and application port 3 384 for communication over a secure socket layer (SSL) connection 314. At time t₄ 354, the server 320 switches to server IP 4 386 and application port 4 388. At time t₅ 358, the client 310 switches to client port 3 360 and the server 320 switches to server IP 5 390 and application port 5 392. The transmissions are over UDP connections 316.

A combination of several communication parameters, i.e., IP address, Port, Protocol, compression method, encryption method, other header information, are changed in such a manner as to not be predicted by an adversary, but which is able to be determined by a friendly node. Accordingly, end hopping is a combination of port and IP hopping along with protocol changes, encryptions changes, compression changes and other header information changes.

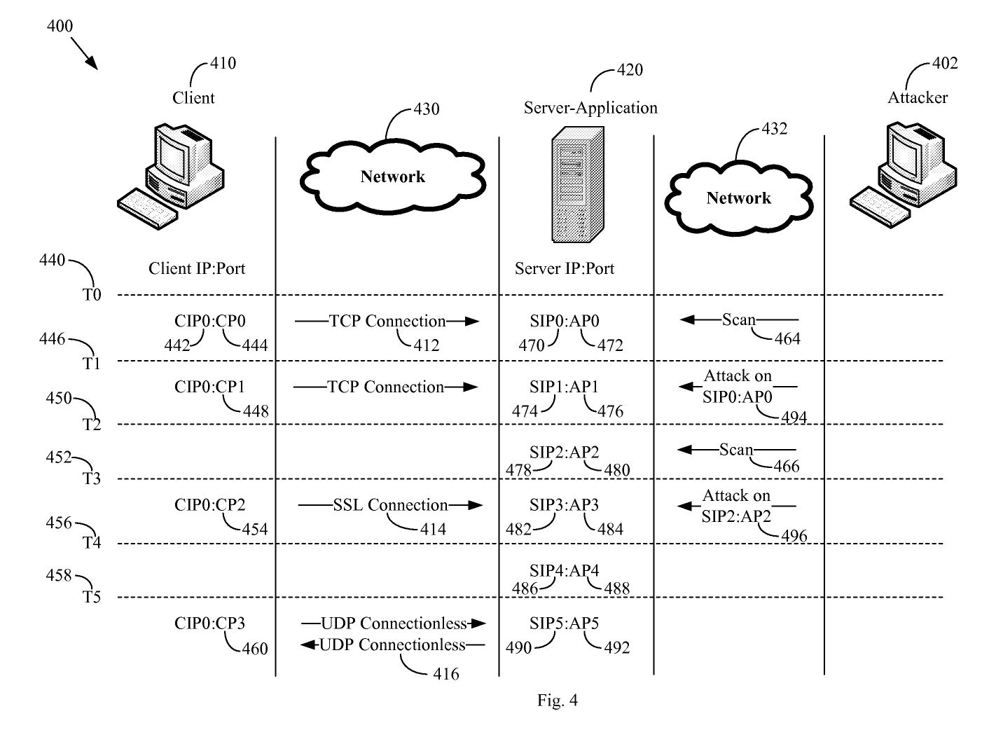

FIG. 4 illustrates scan/attack on a hopping application 400 according to an embodiment. In FIG. 4, a client 410 is coupled to a server 420 through a network 432. An attacker 402 initiates a scan 464 of the server 420 via a network 432.

At time t₀ 440, the client IP (CIP) is CIP0 442 and the client port (CP) is zero, CP0 444. The client 410 accesses the server 420 via the network 430 through a TCP connection 412 using server IP 0 (SIP0) 470 and application port 0 (AP0) 472. At time t₁ 446, the attacker 402 attacks server IP 0 and application port 0 494. However, the client 410 switches to client port 1 448 and the server 420 switches to server IP 1 474 and application port 1 476.

At time t₂ 450, the server 420 switches to server IP 2 478 and application port 2 480. The attacker 402 performs another scan 466. At time t₃ 452, the attacker 402 attacks server IP 2 and application port 2 496. However, the client 410 switches to client port 2 454 and the server 420 switches to server IP 3 482 and application port 3 484 using a secure socket layer (SSL) connection 414. At time t₄ 456, the server 420 switches to server IP 4 486 and application port 4 488. At time t₅ 458, the client 410 switches to client port 3 460 and the server 420 switches to server IP 5 490 and application port 5 492. The transmissions are over UDP connections 416.

Thus, by the time the attacker 402 gets around to attacking the system, e.g., server 420, the system has hopped, thus thwarting the attack. This assumes the host did not change during the time of scan. Obviously, if the attacker 402 can listen to packets, they will see what ports are being used. This defense would be effective against an attacker 402 without application layer access on a hopping system.

If the change rate of the IP/Port is greater that the product of the scan rate, the number of IP addresses and the number of ports, then the adversary will not get a full picture of the network. The network will change before the attacker 402 is able to begin an attack, e.g., before the attacker 402 completes a scan, e.g., scan 464 or scan 466. Thus, if the IP/Port is changed faster than the attacker 402 is able to scan the network, the attacker 402 will remain confused and the attacker 402 will be denied an accurate picture of the network.

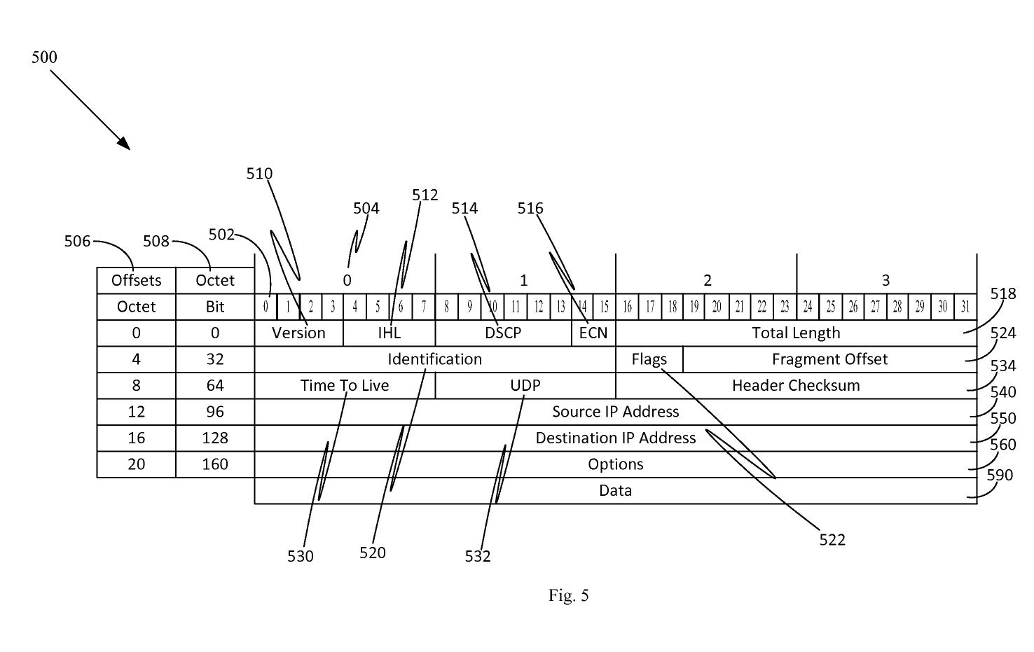

FIG. 5 illustrates an IPv4 header format 500 according to an embodiment. In FIG. 5, the IPv4 header may include 14 fields. The fields in the header 500 are packed with the most significant byte first (big endian), and for the diagram and discussion, the most significant bits are considered to come first, e.g., MSB 0 bit 502. The most significant bit is numbered 0 502, so the version field 510 is actually found in the four most significant bits of the first byte 504. The octet offset 506 and the octet bit 508 for the header 500 are shown on the left. For IPv4, the version field 510 has a value of 4 (hence the name IPv4). The second field (4 bits) is the Internet Header Length (IHL) 512, which is the number of 32-bit words in the header 500. Since an IPv4 header may contain a variable number of options, this field specifies the size of the header 500, which also coincides with the offset to the data 590. Differentiated Services Code Point (DSCP) 514 designates Differentiated services (DiffServ). An example is Voice over IP (VoIP), which is used for interactive data voice exchange. The Explicit Congestion Notification (ECN) field 516 is for end-to-end notification of network congestion without dropping packets. ECN 516 is an optional feature that is used when endpoints support it and are willing to use it. The Total Length field 518 defines the packet (fragment) size, including header and data, in bytes. The Identification field 520 is primarily used for uniquely identifying the group of fragments of an IP datagram. The Flags field 522 follows and is used to control or identify fragments. The Fragment Offset field 524 specifies the offset of a particular fragment relative to the beginning of the original unfragmented IP datagram. The first fragment has an offset of zero.

The Time to Live (TTL) field 530 helps prevent datagrams from persisting (e.g. going in circles) on an internet. This field limits a datagram's lifetime and is specified in seconds. In practice, the field be used as a hop count, e.g., when the datagram arrives at a router, the router decrements the TTL field by one. When the TTL field hits zero, the router may discard the packet and send an ICMP time exceeded message to the sender.

The Protocol field 532 defines the protocol used in the data portion of the IP datagram, e.g., the User Datagram Protocol (UDP). The Header Checksum field 534 is used for error-checking of the header. When a packet arrives at a router, the router calculates the checksum of the header and compares it to the checksum field 534. If the values do not match, the router discards the packet. Errors in the data field must be handled by the encapsulated protocol. When a packet arrives at a router, the router decreases the TTL field. Consequently, the router must calculate a new checksum.

The Source IP Address field 540 is the IPv4 address of the sender of the packet. This address may be changed in transit by a network address translation device. The Destination IP Address field 550 is the IPv4 address of the receiver of the packet. As with the Source Address in the Source IP Address field 540, the Destination IP Address in the Destination IP Address field 550 may be changed in transit by a network address translation device. An Options field 560 is used to convey additional information on the packet or on the way the packet is to be processed. Routers, unless instructed otherwise, process the options in the IPv4 header. However, the processing of most header options pushes the packet into the slow path leading to a forwarding performance hit. A Data field 590 provides a data payload.

The main IPv6 header is equivalent to the basic IPv4 header despite some field differences. For example, functionality of options 560 is removed from the main header and implemented through a set of additional headers called extension headers. Nevertheless, the IHL field 512, Identification field 520, the Flags field 522, the Fragment Offset field 524 and the Header Checksum field 534 are not kept in IPv6. The IPv6 header includes a new flow label field in the IPv6 header that may be used by a source to label a set of packets belonging to the same flow. A flow is uniquely identified by the combination of the source address and of a non-zero Flow label. Multiple active flows may exist from a source to a destination as well as traffic that are not associated with any flow.

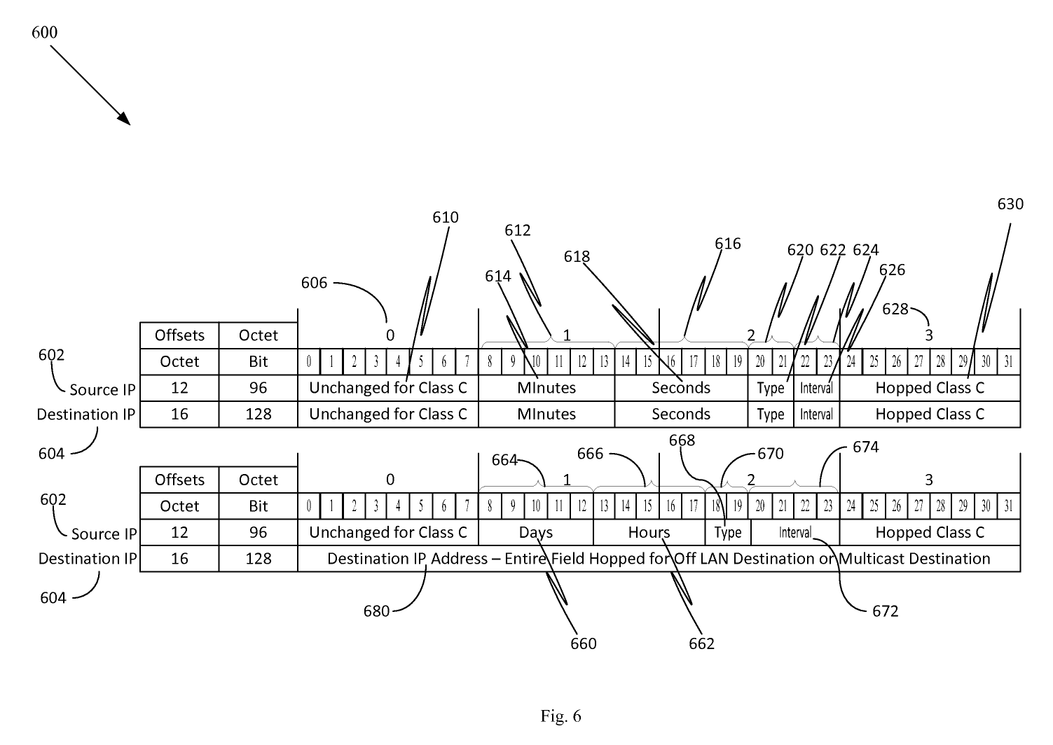

FIG. 6 illustrates hopping on a class C address 600 according to an embodiment. In FIG. 6, the fields for the Source IP address 602 and the Destination IP address 604 are shown. The first octet 606 is unchanged for class C 610. The next 6 bits, i.e., bits 8-13 612 indicates minutes 614, the next 6 bits, i.e., bits 14-19 616 indicates seconds 618, two bits, i.e., bits 20-21 620 indicate a type 622, two bits, i.e., bits 22-23 624 indicate an interval 626 and the last octet 628 indicates the class, i.e., hopped class C 630.

FIG. 6 also shows hopping on a class C address for the Source IP address 602 and the Destination IP address 604 using a different time granularity according to an embodiment. For example, days 660 and hours 662 may be indicated in different octets, e.g., indicated by bits 8-12 664 and bits 13-17 666, respectively, rather than minutes 614 and seconds 618 which used bits 8-13 612 and bits 14-19 616, respectively. The Type field 668 again uses 2 bits 670, but the Interval field 672 now uses 4 bits 674. Moreover, in FIG. 6, the Destination IP address 604 may use the field 680 for hopping for off LAN destinations or multicast destinations.

The bits for the Source IP address 602 and Destination IP address 604 are used during hopping using cyber maneuvering techniques. The placement of the bits shown is the location of the bits inside the adaptor before they are sent to the wire for encode and after they are received from the wire for decode. Additional bytes are not added to the header.

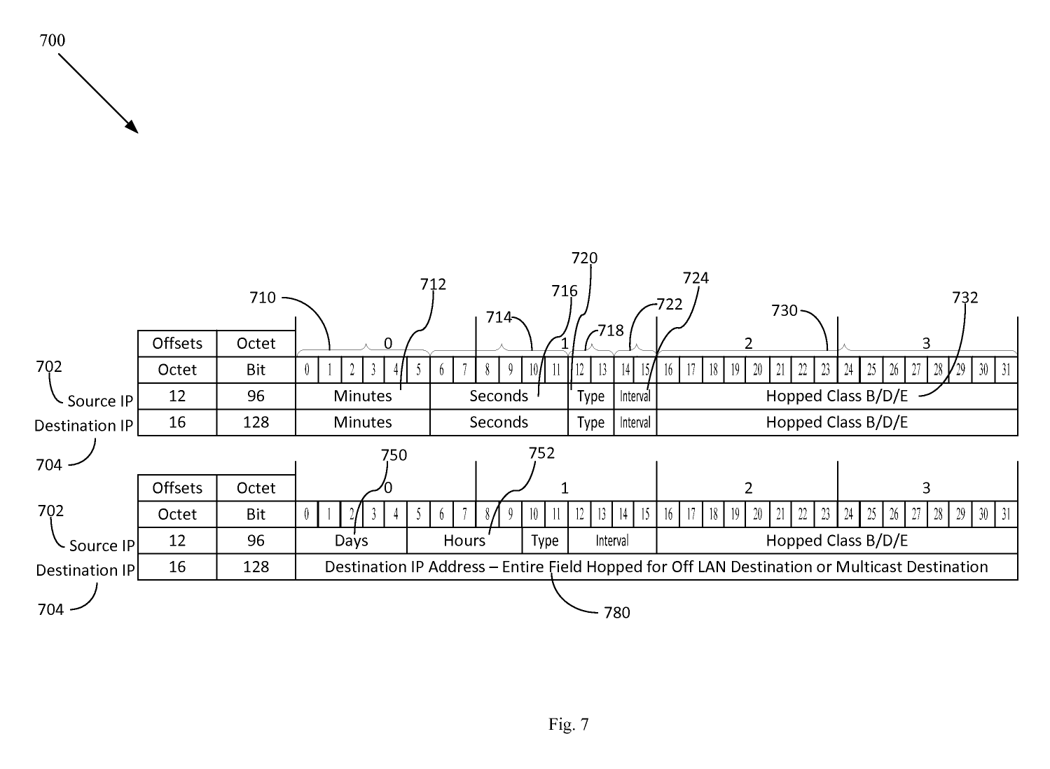

FIG. 7 shows hopping on class B/D/E 700 according to an embodiment. In FIG. 7, the fields for the Source IP address 702 and the Destination IP address 704 are shown. In FIG. 7, the first 6 bits 710 are used to indicate Minutes 712, the next 6 bits 714 are used to indicate Seconds 716, two bits 718 are used for indicating the Type 720 and two bits 722 are used to indicate the Interval 724. The last two octets, i.e., bits 16-31 730, indicate hopping for classes B/D/E 732. As was shown in FIG. 6, FIG. 7 also shows different time granularity, e.g., days 750 and hours 752, may be used. Moreover, in FIG. 7, the Destination IP address 704 may use the field 780 for hopping for off LAN destinations or multicast destinations.

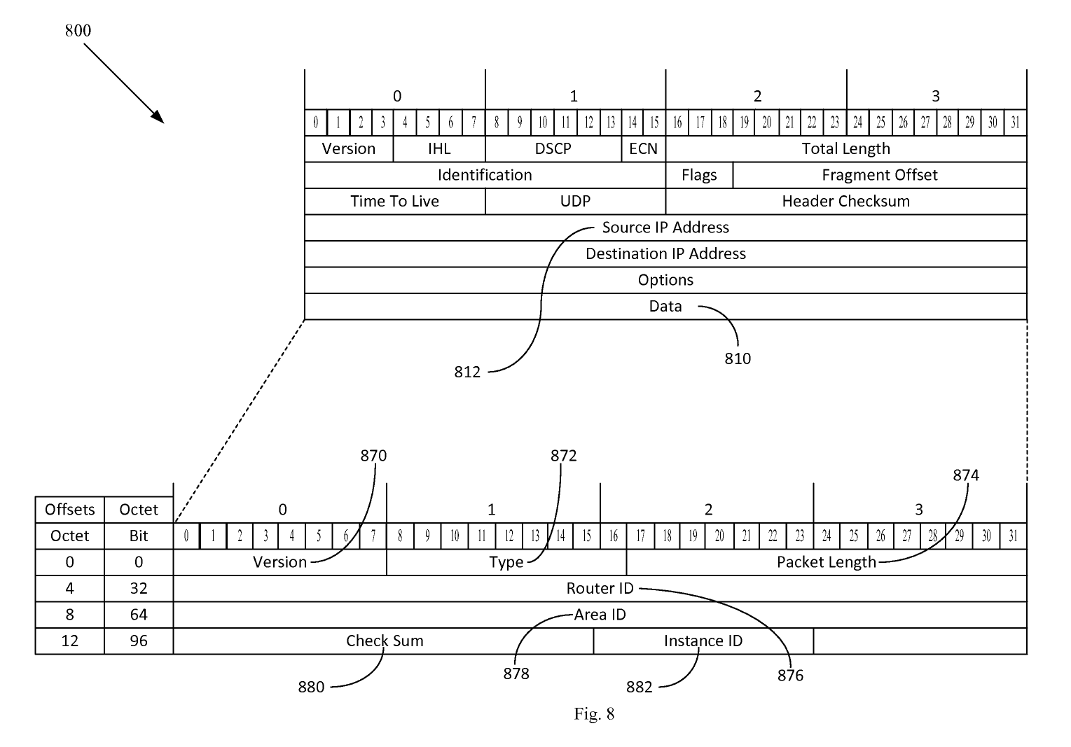

FIG. 8 illustrates an open shortest path first (OSPF) packet 800 according to an embodiment. The OSPF packet 800 is encapsulated in a datagram 810. Source timing from the packet is used by the hopping adaptor to decode the hopping. Multicast IP addresses represent a group of hosts and are used for destination addressing. Therefore the Source IP address 812 is always unique. As a result, each recipient of multicast packets is able to decode them even if their clocks are not synchronized. Multicast maybe used by OSPF link state advertisements, RIP routing table updates and Internet Group Management Protocol (IGMP).

OSPF is a link-state routing protocol for Internet Protocol (IP) networks that uses a link state routing method. Link state information is gathered from available routers and a topology map of the network is constructed. The topology determines the routing table presented to the Internet Layer which makes routing decisions based solely on the destination IP address found in IP packets. Changes in the topology are detected, such as link failures, and a new loop-free routing structure is converged on within seconds. The shortest path tree for each route is computed.

Routers in the same broadcast domain or at each end of a point-to-point telecommunications link form adjacencies when they have detected each other. This detection occurs when a router identifies itself in a hello OSPF protocol packet. This is called a two-way state and is the most basic relationship. The routers in an Ethernet or frame relay network select a Designated Router (DR) and a Backup Designated Router (BDR) which act as a hub to reduce traffic between routers. OSPF uses unicast and multicast to send “hello packets” and link state updates. As a link state routing protocol, OSPF establishes and maintains neighbor relationships in order to exchange routing updates with other routers.

As illustrated in FIG. 8, the OSPF header includes a Version field 870, a Type field 872 identifying the OPSF message type, a Packet Length field 874, a Router ID field 876, an Area ID field 878, a Checksum field 880 and an Instance field 882. The Type field 872 may be used to identify the OPSF message as a hello message, a database description message, a link status request message, a link status update message or a link status acknowledgement message. The Router ID field 876 and Area ID field 878 provide the IP address of the router sending the message and the area number of the sending router. Routing protocol packets are sent with type of service (TOS) of 0. Support for multiple protocol instances on a link is accomplished via the Instance ID field 882 contained in the OSPF packet header and OSPF interface data structures. The Instance ID field 882 affects the reception of OSPF packets and applies to OSPF interfaces and virtual links. Interfaces are assigned an Instance ID in the Instance ID field 882. The default is 0. A value other than 0 is assigned to links that will contain multiple separate communities of OSPF routers.

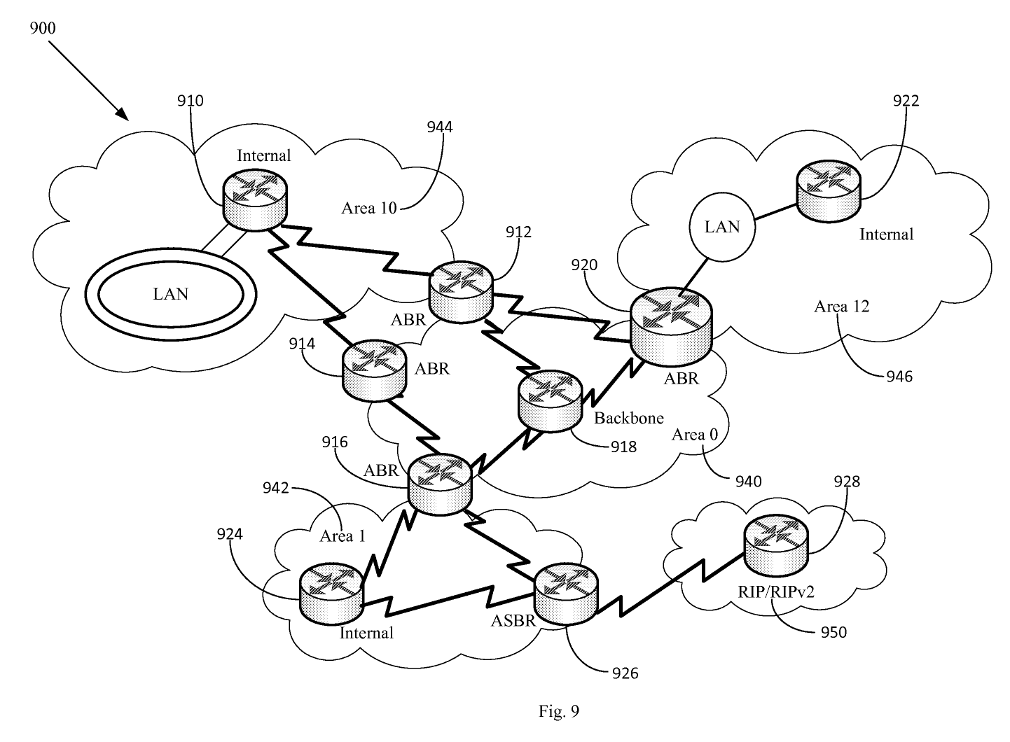

FIG. 9 illustrates a network of routers using OSPF 900 according to an embodiment. Internal Routers, e.g., Routers inside an area 910, 922, 924, 928, Backbone Router 918, e.g., inside area 0 940, Area Border Routers (ABR) 912, 914, 916 920, and Autonomous System Boundary Router (ASBR) 926 are shown. An ABR sits between two or more areas, e.g., area 1 942, area 10 944, area 12 946, and touches a backbone area (area 0 940). Redistribution makes a router an ASBR router 926. In FIG. 9, Area 0 940 thus includes a Backbone Router 918 while four ABR routers, e.g., 912, 914, 916 920, provide the Backbone Router 918 access to internal routers in Area 1 942, Area 10 944 and Area 12 946. An ABR router 916 is also coupled to the ASBR router 926. The ASBR router 926 redistributes packets to a network, e.g., RIP/RIP v2 950. Routers exchange LSAs to build and maintain a database. Updates are sent when changes occur to the network topology.

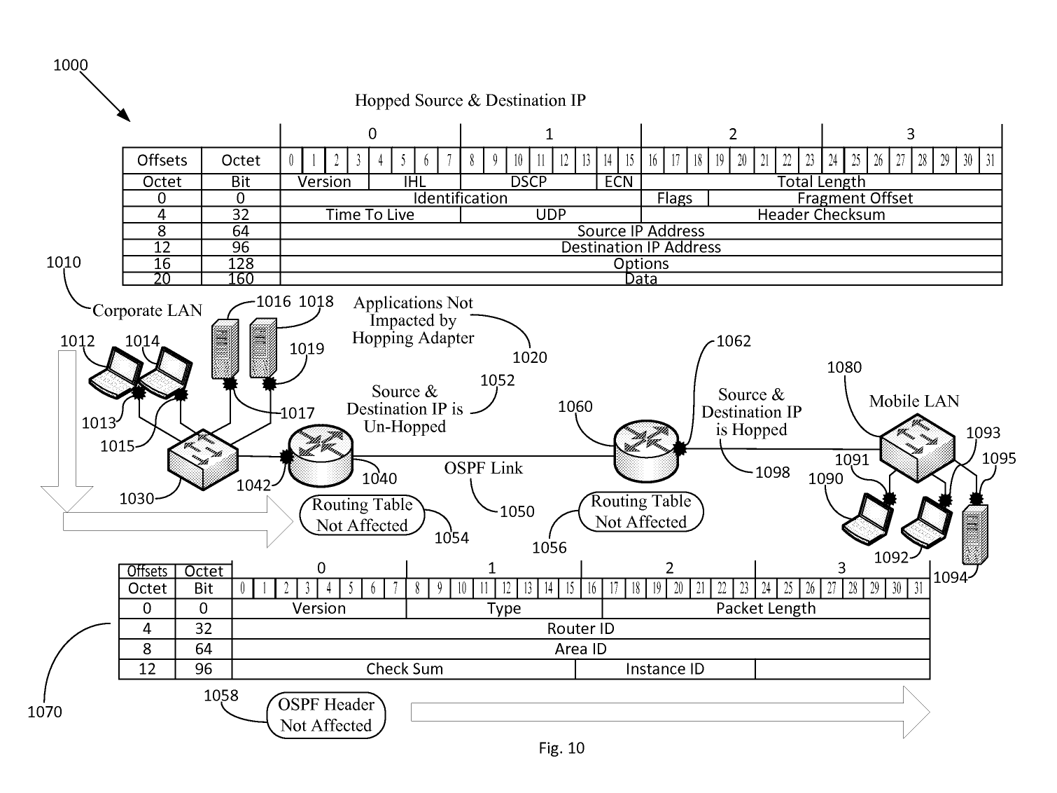

FIG. 10 illustrates packet flow 1000 through OSPF network hopping data according to an embodiment. In FIG. 10, a LAN 1010 is formed by having computing devices 1012, 1014 and servers 1016, 1018 coupled to a first switch 1030. Hopping adapters 1013, 1015, 1017, 1019 may be provided to the computing devices 1012, 1014 and servers 1016, 1018. Applications on the computing devices 1012, 1014 and servers 1016, 1018 are not impacted 1020 by the hopping adaptors adapters 1013, 1015, 1017, 1019. The first switch 1030 is coupled to a first router 1040 that handles packet forwarding and receiving over an OSPF link 1050. The first router also includes a hopping adapter 1042. The source and destination IP are unhopped 1052 at the first router 1040. At the other end of the OSPF link 1050 is a second router 1060. The routing table for the first router 1040 and the second router 1060 and the OSPF Header 1070 are not affected 1054, 1056, 1058. The second router 1060 includes a hopping adapter 1062 and is coupled to a second switch 1080. The second switch 1080 is coupled to additional computing devices 1090, 1092 and servers 1094. The additional computing devices 1090, 1092 and servers 1094 that are coupled to the second switch 1080 may also include hopping adaptors 1091, 1093, 1095. At the second router, the source and IP address are hopped 1098.

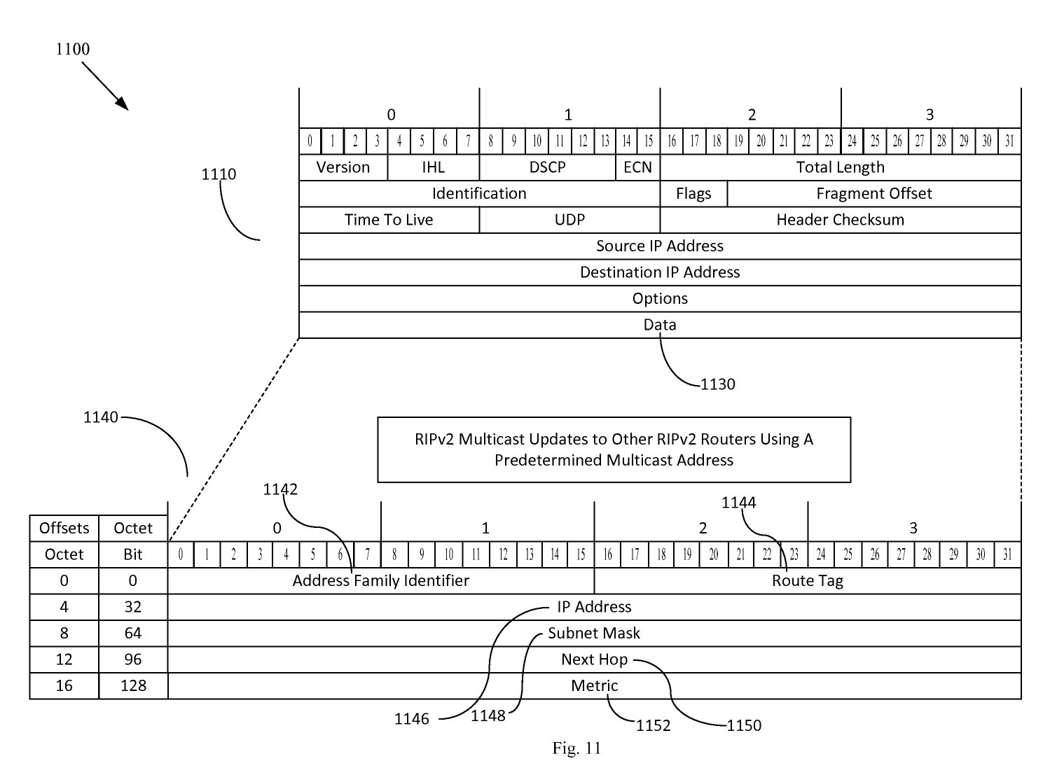

FIG. 11 illustrates a routing information protocol (RIP) version two (v2) packet 1100 according to an embodiment. RIP (Routing Information Protocol) is a standard for exchange of routing information among gateways and hosts and RIPv2 is an UDP-based protocol. In FIG. 11, the IPv4 header 1110 is shown. However, the RIPv2 packet 1140 provided in the datagram 1130 includes an Address Family Identifier field 1142, a Route Tag field 1144, and IP Address field 1146, a Subnet Mask field 1148, a Next Hop field 1150 and a Metric field 1152.

The Address family identifier in the Address Family Identifier field 1142 indicates what type of address is specified in this particular entry. This is used because RIP2 may carry routing information for several different protocols. The address family identifier for IP is 2. The Route Tag in the Route Tag field 1144 is an attribute assigned to a route which must be preserved and re-advertised with a route. The Route Tag provides a method of separating internal RIP routes, i.e., routes for networks within the RIP routing domain, from external RIP routes, which may have been imported from an Exterior Gateway Protocol (EGP) or another Interior Gateway Protocol (IGP). The IP address field 1146 provides the destination IP address. The Subnet Mask field 1148 provides a value applied to the IP address to yield the non-host portion of the address. If zero, then no subnet mask has been included for the entry. The Next Hop field 1150 is used to indicate the immediate next hop IP address to which packets to the destination specified by this route entry are to be forwarded. The Metric field 1152 is used to identify the total cost of getting a datagram from the host to that destination. The metric in the Metric field 1152 is the sum of the costs associated with the networks that would be traversed in getting to the destination.

The packet flow through RIPv2 network using hopping according to an embodiment is similar to the flow shown in FIG. 10. The source and destination IP address are not hopped at the first router. The source and destination IP address are hopped at the second router. The routing tables for the two routers are not affected and the RIPv2 header is not affected.

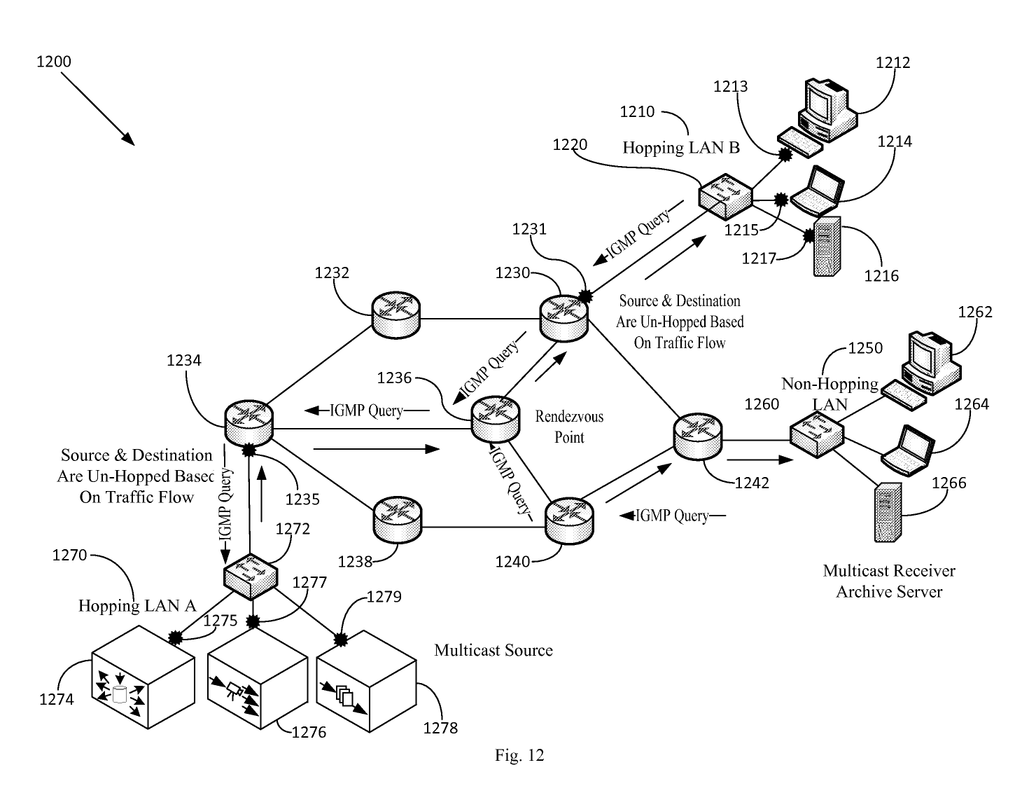

FIG. 12 illustrates multicast flow 1200 according to an embodiment. In FIG. 12, Hopping LAN B 1210 is shown to include a plurality of computing devices 1212, 1214 and a server 1216. The computing devices 1212, 1214 and a server 1216 may operate as multicast receivers. The plurality of computing devices 1212, 1214 and the server 1216 include Hopping Adapters 1213, 1215, 1217 and are coupled to a first switch 1220. The first switch 1220 is coupled to a first router 1230. Multiple paths are provided by second router 1232, third router 1234, fourth router 1236, fifth router 1238, sixth router 1240 and seventh router 1242. A Non-Hopping LAN 1250 is formed by a second switch 1260 that is coupled to the seventh router 1242 and, as shown, a plurality of computing devices 1262, 1264 and a Multicast Receiver/Archive server 1266. Hopping LAN A 1270 includes a third switch 1272 and a plurality of Multicast Sources 1274, 1276, 1278. Additional Hopping Adapters 1275, 1277, 1279 are provided at the first 1274, second 1276 and third 1278 Multicast Source as well as hopping adapters 1231, 1235 being provided at first router 1230 and third router 1234, respectively.

In FIG. 12, multicast flow may be provided from Hopping LAN B 1210 to Hopping LAN A 1270. For example, the Multicast Receiver 1216 on Hopping LAN B 1210 may send a multicast query to the Multicast Sources 1274, 1276, 1278 on Hopping LAN A 1270. A Hopping Adapter 1231 on the first router 1230 decodes the hopped source unicast IP and Multicast destination address for routing. The third router 1234 at Hopping LAN A 1270 receives the multicast request and the Hopping Adaptor 1235 encodes the source unicast address and the destination multicast address from Hopping LAN B 1210. The opposite is true for the return path, i.e., from Hopping LAN A 1270 to Hopping LAN B 1210.

However, packets may also be sent from the Non-Hopping LAN 1250 to Hopping LAN A 1270. The multicast request packet from the Non-Hopping LAN 1250 is not encoded until it reaches the Hopping Adapter 1235 at the third router 1234 at Hopping LAN A 1270. On the return path the Hopping Adaptor 1235 decodes the packet for the third router 1234 to send the packet back to the originator, i.e., the Non-Hopping LAN 1250.

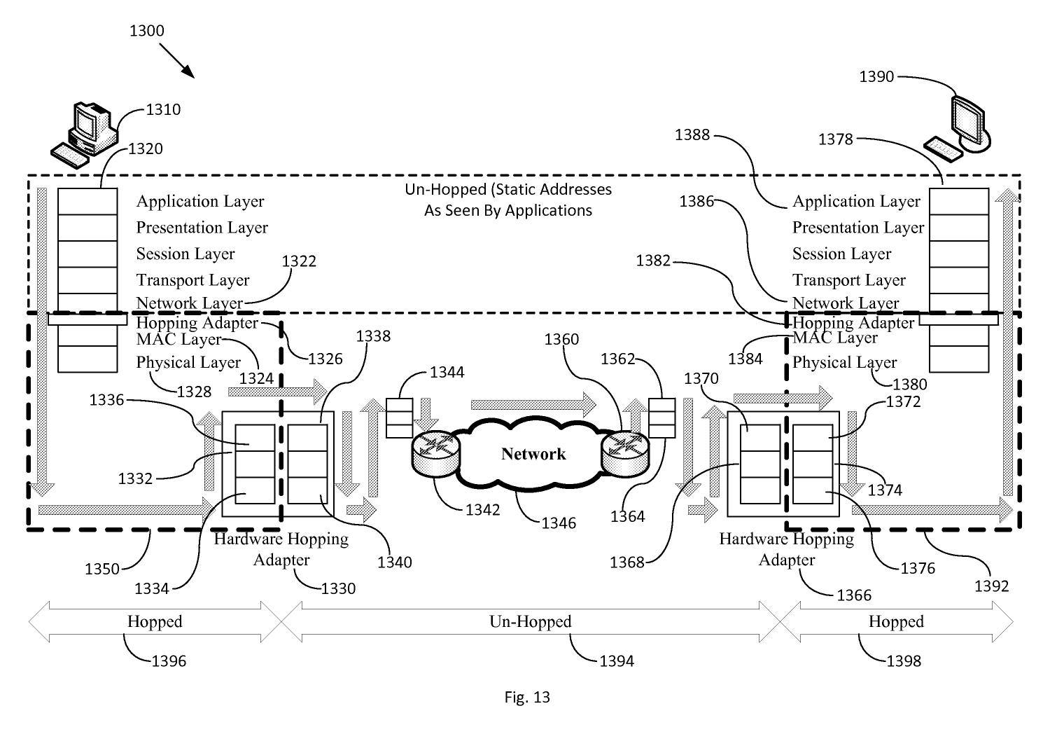

FIG. 13 illustrates hopped and un-hopped data flow 1300 according to an embodiment. In FIG. 13, a sending device 1310 communicates with a receiving device 1390. At the sending device 1310, an application uses a first protocol stack 1320, wherein a hopping adapter 1322 is shown in the protocol stack 1320 between the network layer 1324 and the MAC layer 1326. Packets are provided to the physical layer 1328 where they traverse Hopping LAN A, where they are provided to a hardware hopping adapter 1330.

The hardware hopping adapter 1330 includes a first protocol stack 1332 that receives the packets at a physical layer 1334 where the packets are passed to the network layer 1336. At the network layer 1336 of the first protocol stack 1332 of the hardware hopping adapter 1330, packets are provided to a second protocol stack 1338 where the packets are passed to a physical layer 1340 of the second protocol stack 1338. From the physical layer 1340 of the second protocol stack 1338 packets are provided to a first router 1342. The first protocol stack 1332 of the hardware hopping adapter 1330 and the MAC layer 1326 and physical layer 1328 form a first hopping local area network (LAN), Hopping LAN A 1350.

At the first router 1342, packets are processed through the network layer 1344 and then are routed over a network 1346, such as the Internet, a wireless area network, etc. A second router 1360 receives the packets from the network 1346, where the packets are processed through the network layer 1362 and then back down to the physical layer 1364. There the packets are provided to a second hardware hopping adapter 1366. The second hardware hopping adapter 1366 includes a first protocol stack 1368 and the packets are processed up to the network layer 1370. There the packets are provided to a network layer 1372 of a second protocol stack 1374 of the second hardware hopping adapter 1366. Packets processed through the second protocol stack 1338 of the first hardware hopping adapter 1330, the first router 1342, the network 1346, the second router 1360 and the first protocol layer 1368 of the second hardware hopping layer 1366 are un-hopped.

The network layer 1372 of the second protocol stack 1374 of the second hardware hopping adapter 1366 passes packets to the physical layer 1376 where the packets are passed to a protocol stack 1378 of the receiving device 1390. The packets are processed up the protocol stack 1378 of the receiving device 1390 from the physical layer 1380 through a hopping adapter 1382 between the MAC layer 1384 and the network layer 1386 to an application layer 1388. A second hopping LAN, hopping LAN B 1392 is formed from the second protocol stack 1376 of the second hardware hopping adapter 1366 to the hopping adapter 1882 of the receiving device 1390.

Accordingly, the applications at the sending device 1310 and the receiving device 1390 use static address and the processing appears un-hopped to the applications. Packets are also un-hopped 1394 between the hardware hopping adapters 1330, 1366. However, within hopping LAN A 1350 and hopping LAN B 1392, packets are hopped 1396, 1398.

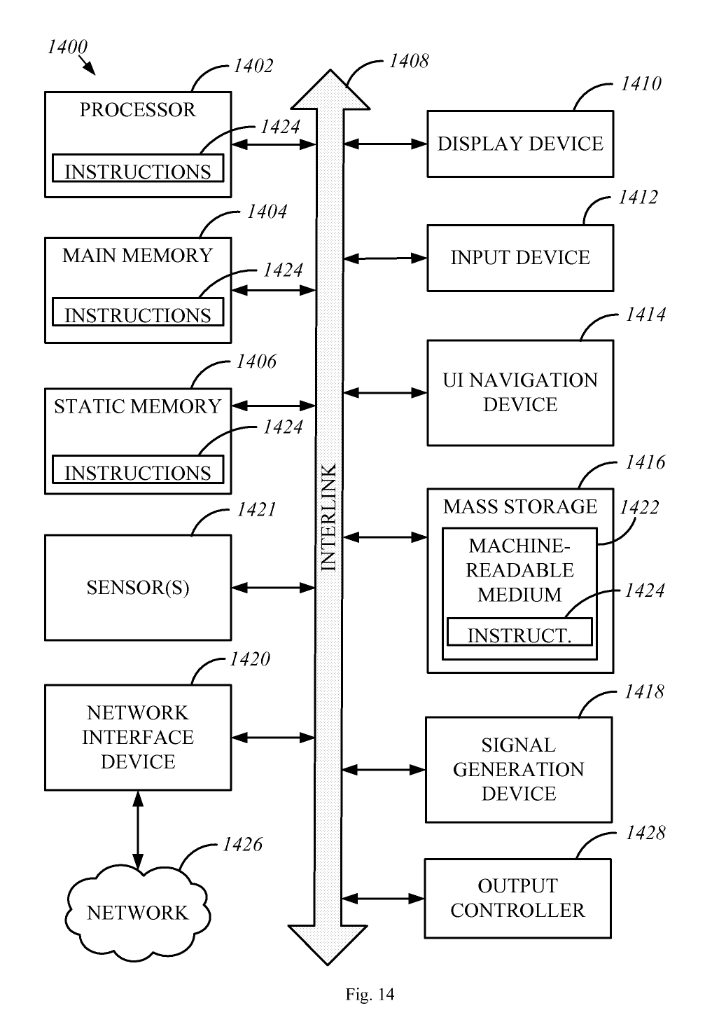

FIG. 14 illustrates a block diagram of an example machine 1400 for selecting unique next-time-interval internet protocol address and port according to an embodiment upon which any one or more of the techniques (e.g., methodologies) discussed herein may perform. Machine 1400 may implement hopping adaptor functions as described herein. In alternative embodiments, the machine 1400 may operate as a standalone device or may be connected (e.g., networked) to other machines. In a networked deployment, the machine 1400 may operate in the capacity of a server machine and/or a client machine in server-client network environments. In an example, the machine 1400 may act as a peer machine in peer-to-peer (P2P) (or other distributed) network environment. The machine 1400 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, at least a part of one or more computer systems (e.g., a standalone, client or server computer system) or one or more hardware processors 1402 may be configured by firmware or software (e.g., instructions, an application portion, or an application) as a module that operates to perform specified operations. In an example, the software may reside on at least one machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor 1402 configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

Machine (e.g., computer system) 1400 may include a hardware processor 1402 (e.g., a central processing unit (CPU), a graphics processing unit (GPU), a hardware processor core, or any combination thereof), a main memory 1404 and a static memory 1406, at least some of which may communicate with others via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1416, a signal generation device 1418 (e.g., a transmitter, a speaker, etc.), a network interface device 1420, and one or more sensors 1421, such as a global positioning system (GPS) sensor, compass, accelerometer, or other sensor. The machine 1400 may include an output controller 1428, such as a serial (e.g., universal serial bus (USB), parallel, or other wired or wireless (e.g., infrared (IR)) connection to communicate with another node in a network or control one or more peripheral devices (e.g., a printer, card reader, etc.). Signal generation device 1418 may accept packets created by processor 1402 as described herein above for transmission using network interface device 1420.

The storage device 1416 may include at least one machine readable medium 1422 on which is stored one or more sets of data structures or instructions 1424 (e.g., software) embodying or utilized by any one or more of the techniques or functions described herein. The instructions 1424 may also reside, at least partially, additional machine readable memories such as main memory 1404, static memory 1406, or within the hardware processor 1402 during execution thereof by the machine 1400. In an example, one or any combination of the hardware processor 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, and/or associated caches and servers) that configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

For example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1400, and includes digital or analog communications signals or other intangible medium to facilitate communication of such software.

Accordingly, embodiments described herein provide a sparsely populated IP address space with hosts or an application that performs IP addresses hopping to deny attackers information about the system. Moreover, embodiments described herein provide a mechanism to fight through when a network is under attack. In battle, if a few planes, tanks or troops are lost, the battle space is not abandoned. However, this is what occurs today when a server is compromised. The server is disconnected from the network and forensics or recovery is initiated. However, sparse address space may be used to hide the defenders.

If the change rate of the IP/Port is greater than the product of the scan rate of an adversary, the number of IP addresses and the ports, then the adversary will not obtain a full picture of the network. The network will change before the adversary can begin an attack and finish a scan. Therefore, IP hopping according to embodiments described herein may be used so that a network may continue to operate even when under attack or when an adversary tries to scan, infiltrate, or disturb communications between clients and servers.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for providing a next-time-interval routing parameter to a destination node, comprising:
calculating, at a sending node, a hopped routing parameter using a static routing parameter of a destination node;
encoding the hopped routing parameter and a system time at the sending node including inserting a representation of the system time at the sending node, wherein the system time at the sending node is independent of a system time at the destination node such that synchronization of the sending node and the destination node is not required; and
providing the encoded hopped routing parameter and the representation of the system time at the sending node in address fields of packets by replacing an address of the sending node and an address of the destination node in the packets.

2. The method of claim 1, wherein the calculating the hopped routing parameter further comprises calculating at least one of an IP address, a port number and a hopping local area network identifier.

3. The method of claim 1, wherein the calculating the hopped routing parameter further comprises providing a unique mapping for internet protocol (IP) addresses and ports for hops having a selected time interval.

4. The method of claim 3, wherein the calculating the hopped routing parameter using the static routing parameter comprises calculating the hopped routing parameter to guarantee no collisions for the selected time interval.

5-6. (canceled)

7. The method of claim 1, wherein field information for the address of the sending node is encoded when hopping and, when sending off the hopping network, no hopping of the address of the destination node is performed.

8. The method of claim 1, wherein the encoding the hopped routing parameter and the system time at the sending node comprises encoding the hopped routing parameter according to a high assurance internet protocol.

9. The method of claim 1, wherein the calculating the hopped routing parameter further comprises calculating multicast IP addresses for open shortest path first (OSPF) link state advertisements, routing information protocol (RIP) routing table updates and internet group management protocol (IGMP) to establish multicast group memberships.

10. The method of claim 1, wherein the encoding the hopped routing parameter and the system time at the sending node includes encoding source field information when hopping, wherein a destination address is not hopped when sending the packets off the hopping network.

11. The method of claim 1, wherein the calculating, at the sending node, the hopped routing parameter using a static routing parameter of a destination node further comprises providing a same static destination a different hopped address as a packet for the static destination traverses different networks.

12. The method of claim 1, wherein the providing the encoded hopped routing parameter and the system time at the sending node in the address fields of packets comprises providing a unique mapping for IP addresses and ports for given time interval hops without synchronizing time among nodes.

13. The method of claim 1, wherein the encoding the hopped routing parameter and the system time at the sending node further comprises using a hopping local area network identifier to enable use of multiple instances of the encoding the hopped routing parameter and source timing in a same physical LAN.

14. A method for determining a next-time-interval routing parameter at a destination node, comprising:
receiving a packet from a sending node having encoded hopped routing parameter and source timing in an address field of the received packet using the source timing from the received packet by a hopping adapter at the destination node to decode a next hop for the received packet, independent of a system time at the destination node such that the sending node and the destination node are not synchronized;
decoding, using the source timing, the hopped routing parameter and the source timing in the address field of the received packet, independent of the system time at the destination node; and
using the decoded hopped routing parameter and the source timing to perform route hopping with the sending node.

15. The method of claim 14, wherein the using the decoded hopped routing parameter and the source timing to perform route hopping with the sending node provides a unique mapping for IP addresses and ports for given time interval hops.

16. The method of claim 14, wherein the using the decoded hopped routing parameter and the source timing enables system times to vary between an encoding node and a decoding node without affecting the route hopping with the sending node.

17. The method of claim 14, wherein the using the decoded hopped routing parameter and the source timing to perform route hopping with the sending node comprises mapping from time interval to time interval in a pseudo-random fashion to prevent prediction of next time interval values.

18. (canceled)

19. A hopping adapter, comprising:
a network interface device arranged to connect to a network;
a signal generation device, coupled to the network interface device, the signal generation device arranged to transmit packets onto a network via the network interface device; and
a processor arranged to process packets for transmission on the network and to process packets received from the network, the processor further arranged to calculate a hopped routing parameter using a static routing parameter of a destination node, to encode the hopped routing parameter using and source timing at a sending node, independent of a system time at a destination node such that the sending node and the destination node are not synchronized, to provide the encoded hopped routing parameter and source timing in address fields of packets by replacing the address of the sending node and an address of the destination in the packets and to provide the packets to the signal generation device for transmission.

20. The hopping adapter of claim 19, wherein the processor is further arranged to calculate at least one of an IP address and a port number.

21. The hopping adapter of claim 19, wherein the processor is further arranged to encode a source timing independent of a system time at a destination node.

22. The hopping adapter of claim 19, wherein the processor is further arranged to encode the hopped routing parameter according to a high assurance internet protocol.

23. The hopping adapter of claim 19, wherein the processor is further arranged to use a hopping local area network identifier to enable coexistence of multiple instances of the encoding the hopped routing parameter and source timing in a same physical LAN.

24. The hopping adapter of claim 19, wherein the processor is further arranged to identify a received packet having encoded hopped routing parameter and source timing in an address field of the received packet, to decode the hopped routing parameter and the source timing in the address field of the received packet and to use the decoded hopped routing parameter and the source timing to perform route hopping.
